(19) United States
(12) Patent Application Publication
(10) Pub. No.: US 2010/0037980 A1
(43) Pub. Date: Feb. 18, 2010

(54) APPARATUS AND METHOD FOR SEPARATING TWISTED PAIR CABLE

(75) Inventors: Frank Gerwin Kaufhold, Suffolk (GB); Ian Albert Edward Swann, Suffolk (GB); John Richard Willoughby, Essex (GB); George William Francis, Suffolk (GB)

Correspondence Address: MCGARRY BAIR PC, 32 Market Ave. SW, SUITE 500, GRAND RAPIDS, MI, 49503, US

(73) Assignee: UNITED TECHNOLOGISTS EUROPE LIMITED, Suffolk (GB)

(21) Appl. No.: 12/522,578

(22) PCT Filed: Feb. 8, 2008
(86) PCT No.: PCT/GB08/50079

§ 371 Date: Jul. 9, 2009

(30) Foreign Application Priority Data
Mar. 6, 2007 (GB) 0704300.3
Mar. 26, 2007 (GB) 0705717.7
Oct. 17, 2007 (GB) 0720236.9

(51) Int. Cl. H01R 43/28; B21F 1/02

(52) U.S. Cl. 140/147; 29/419.1; 29/762

(57) ABSTRACT

An apparatus (1, 2, 20) and method are provided for separating a length of twisted pair cable (10) into its constituent individual insulated wire conductors (11, 12) for subsequent use in telecommunications networks or other electrical equipment. The apparatus (1, 2, 20) includes a separator (15, 66) adapted for insertion between the individual insulated wire conductors (11, 12) constituting the twisted pair cable (10). Cable drive means are provided to cause displacement of the length of twisted pair cable (10) relative to the inserted separator (15, 66) in a direction (a, b) co-incident with the axis of the twisted pair cable (10). In addition to separating the insulated wire conductors (11, 12), the driving (a, b) of the twisted wire cable (10) past the separator (15, 66) also causes plastic deformation of the individual insulated wire conductors (11, 12) thus preventing them from springing back into their initial wound state. A length of cable comprising a pair of substantially parallel separated individual insulated wire conductors (11, 12) is thus produced.

This invention relates to an apparatus and method for separating a length of twisted pair cable into its constituent individual insulated wire conductors. In particular, the invention relates to fully automated apparatus for performing this operation, and to a method of performing this operation utilising such automated apparatus.

A twisted pair cable is a form of electrical wiring, commonly used in telecommunications networks. The twisted pair cable comprises two individual insulated wire conductors, which are wound together primarily to reduce interference, and also to increase the strength of the wire. The twisting of wires in this way is therefore highly desirable. However, whenever a connection is made using twisted pair cable, for example when making so-called ‘jumper’ connections in telecommunications network distribution frames, portions at each end of the twisted pair cable must be unwound to form lengths of parallel, separated insulated wire conductors.

Conventionally, this operation is performed by hand, or using simple hand-operated tools. The process therefore tends to be slow, labour intensive and susceptible to error. A typical telecommunications network distribution frame can comprise many thousands of individual connections, requiring constant maintenance and re-wiring. The introduction of automated wiring systems is therefore highly desirable.

The present invention seeks to provide an automated apparatus and method for separating a length of twisted pair cable into its component pair of insulated wire conductors, presenting a length of separated, parallel insulated wire conductors for subsequent machine manipulation and/or connection. In certain embodiments thereof, the invention further seeks to provide an automated apparatus and method for positioning and clamping the twisted pair cable prior to separation.

The present invention has been developed for use in telecommunications network distribution frames, and will be described herein with particular reference to this application. It should nevertheless be appreciated that the apparatus and method of the present invention may find use in a wide range of other applications where the automated preparation of electrical wiring is desirable.

According to a first aspect of the present invention there is provided apparatus for separating a length of twisted pair cable into its constituent individual insulated wire conductors, comprising:

a separator adapted for insertion between the individual insulated wire conductors constituting the twisted pair cable; and

cable drive means adapted to displace said length of twisted pair cable relative to the inserted separator in a direction co-incident with the axis of the twisted pair cable, thereby causing plastic deformation of the individual insulated wire conductors so as to form a length of cable comprising a pair of substantially parallel separated individual insulated wire conductors.

Effecting plastic deformation of the individual insulated wire conductors ensures that said conductors remain separated and do not ‘spring’ back into their previously wound state.

The apparatus preferably further comprises separator drive means adapted to move said separator between an inactive position in which the separator is withdrawn from the twisted pair, and an active position in which the separator is inserted between the individual insulated wire conductors constituting the twisted pair cable.

The cable drive means is preferably adapted to effect translational motion of the twisted pair cable. Most preferably the cable drive means is adapted to effect translational motion of the cable in a first direction (hereinafter referred to as forward translational motion) thereby to present said cable to the separator prior to insertion thereof, and then to effect translational motion of the cable in a substantially opposite direction (hereinafter referred to as reverse translational motion) subsequent to insertion of the separator, thereby to separate the individual insulated wire conductors and cause plastic deformation thereof.

In preferred embodiments of the present invention, the cable drive means is adapted again to effect forward translational motion of the insulated wire conductors following separation thereof. This enables presentation of the separated conductors for cutting, so as to form prepared ends for insertion into an insulated displacement connector in a telecommunications network distribution frame, or other electrical apparatus.

The separator drive means is preferably adapted to hold the separator in its active position whilst the cable drive means effects displacement of the cable relative to the separator, in order to ensure effective separation and plastic deformation of the individual insulated wire conductors.

The apparatus of the present invention is intended to be fully automated, in order to increase the speed of the operations performed, and to reduce labour intensity. It is therefore highly desirable that the apparatus further comprises an automated controller in communication with the cable drive means and the separator drive means, and adapted thereby to generate pre-determined lengths of separated cable on demand. The automated controller may either be provided as an integral component of the present invention, or alternatively may be provided at a remote location.

In a first major embodiment of the apparatus of the present invention, the separator drive means is adapted to effect translational motion of the separator between its inactive and active positions. The separator drive means may be adapted to operate by any suitable means, for example, electrically, mechanically, hydraulically or pneumatically. Most preferably, the separator drive means in the first major embodiment comprises a servo mechanism adapted to drive the separator from its inactive position to its active position.

Similarly, the separator itself may take any form suitable for insertion between the insulated wired conductors of the twisted pair cable. Preferably however, the separator in the first major embodiment comprises an elongate pin, blade or mechanical finger. Most preferably, the separator is arranged for movement in a direction co-incident with its longitudinal axis.

In variations of the first major embodiment, the apparatus further comprises a clamping mechanism adapted to secure the twisted pair cable between first and second clamping surfaces, thereby to facilitate insertion of the separator.

In a first variation of the first major embodiment, the clamping mechanism comprises a fixed body on which the first clamping surface is provided, a moveable platform on which the second clamping surface is provided, and clamping drive means adapted to move the platform between an inactive position in which the first and second clamping surfaces are distal, and an active position in which the first and second clamping surfaces are brought into close proximity, thereby to effect clamping of the twisted pair cable.

The platform preferably comprises an aperture extending through the second clamping surface and adapted to receive the separator therein. In such embodiments, the separator is preferably arranged for movement through said aperture thereby to separate the individual insulated wire conductors.

The second clamping surface may desirably comprise a channel adapted to accommodate the twisted pair cable. Most preferably, the channel is further provided with angled sidewalls, such that the separator acts to urge each respective individual insulated wire conductor against an opposed angled sidewall. The fixed body of the apparatus may desirably also comprise a like channel, adapted to communicate with the channel in the second clamping surface when the platform is in its inactive position.

The separator and platform are preferably configured such that the platform is arranged for movement in a direction co-incident with the longitudinal axis of the separator. This further enables the apparatus to be adapted such that activation of the separator drive means in turn actuates the clamping drive means.

The clamping drive means preferably comprises a pre-tensioned spring mounted on the moveable platform and adapted to apply a force thereto upon compression of said spring. The spring acts to re-set the platform and/or the separator to the inactive position after each operation, and ensures that the channel in the platform is fully aligned with the like channel in the fixed body, when the platform is in its inactive position.

In a second variation of the first major embodiment, the clamping mechanism comprises a pair of opposed arms arranged perpendicular to the longitudinal axis of the separator, and adapted to clamp the twisted pair cable from either side, in the axial plane of the cable, the members of said pair of opposed arms constituting, respectively, the first and second clamping surfaces. The opposed arms define a channel therebetween adapted to receive the twisted pair cable. The opposed arms are preferably adapted to move in concert with the motion of the separator, so as both to clamp the wire and to change the profile of the channel according to the status of the cable—i.e. to present a different profile to the cable when it is in its twisted pair configuration and when it is separated into individual insulated wire conductors.

In a second major embodiment of the apparatus of the present invention, the separator drive means is adapted to effect rotational motion of the separator between its inactive and active positions. To achieve this, the separator drive means preferably comprise a cam mounted on a cam shaft and having a surface adapted to bear against the twisted pair cable as the cam rotates; the separator being provided at a location on said surface.

The separator may take the form of a conventional cam lobe, or may be a simple projection extending from the cam surface. Preferably however, the cam is a cylindrical cam having at least one groove extending at least part way therearound and adapted to receive the twisted pair cable. In such embodiments, the groove constitutes the surface adapted to bear against the twisted pair cable; the separator being formed in the groove and projecting outwardly therefrom.

The apparatus preferably further comprises guide means for aligning the separator with the twisted pair cable. Most preferably, the guide means are mounted on the cam and rotate therewith. In the preferred embodiments comprising a cylindrical cam, the groove preferably defines a pair of opposed side walls constituting the guide means.

The groove in the cylindrical cam preferably has a generally U-shaped profile in order to accommodate the twisted pair cable. Most preferably, the groove divides into a pair of opposed parallel sub-grooves adjacent the separator, each said sub-groove being adapted to receive one member of the pair of insulated wire conductors, and wherein one member of said pair of sub-grooves passes either side of the separator, thereby to facilitate separation of the twisted pair cable.

The separator preferably has a tapered profile adapted to facilitate insertion thereof between the individual insulated wire conductors constituting the twisted pair cable. The tapered profile of the separator may desirably form a blade, pin or finger-shaped structure for insertion between the individual insulating wire conductors of the twisted pair cable.

According to a further aspect of the present invention, there is provided a method of separating a length of twisted pair cable into its constituent individual insulated wire conductors, said method comprising:

inserting a separator between the individual insulated wire conductors constituting the twisted pair cable; and

displacing said length of twisted pair cable relative to the inserted separator in a direction co-incident with the axis of the twisted pair cable, thereby causing plastic deformation of the individual insulated wire conductors, so as to form a length of cable comprising a pair of substantially parallel separated individual insulated wire conductors.

The separator is preferably driven between an inactive position in which the separator is withdrawn from the twisted pair, and an active position in which the separator is inserted between the individual insulated wire conductors constituting the twisted pair cable.

The twisted pair cable is preferably driven in a forward translational motion to present said cable to the separator prior to insertion thereof, and is then driven in a reverse translational motion subsequent to insertion of the separator, thereby to separate the individual insulated wire conductors and cause plastic deformation thereof. The separator is preferably held in its active position whilst the cable is displaced relative to the separator, thereby to separate the individual insulated wire conductors and cause plastic deformation thereof.

In a first major embodiment of the method of the present invention, the driving of the separator between its inactive and active positions is effected by translational motion. A variation of the method of the first major embodiment further comprises the step of clamping the twisted pair cable prior to insertion of the separator so as to hold the twisted pair cable in position for separation. In such embodiments, the driving of the separator between its inactive and active positions may preferably also initiate clamping of the twisted pair cable.

In a second major embodiment of the method of the present invention, the driving of the separator between its inactive and active positions is effected by rotational motion. In such embodiments, the rotational motion of the separator may desirably effect both clamping and separation of the twisted pair cable.

The scope of the present invention encompasses a method as hereinbefore described utilising apparatus as hereinbefore described.

In order that the present invention may be fully understood, preferred embodiments thereof will now be described in detail, though only by way of example, with reference to the accompanying drawings, in which:

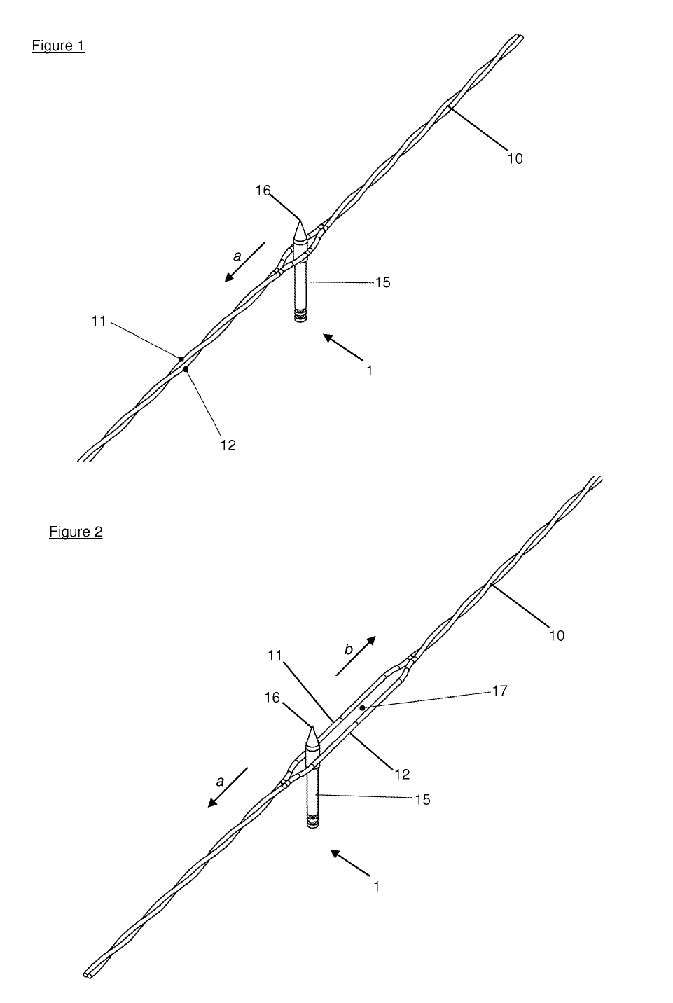

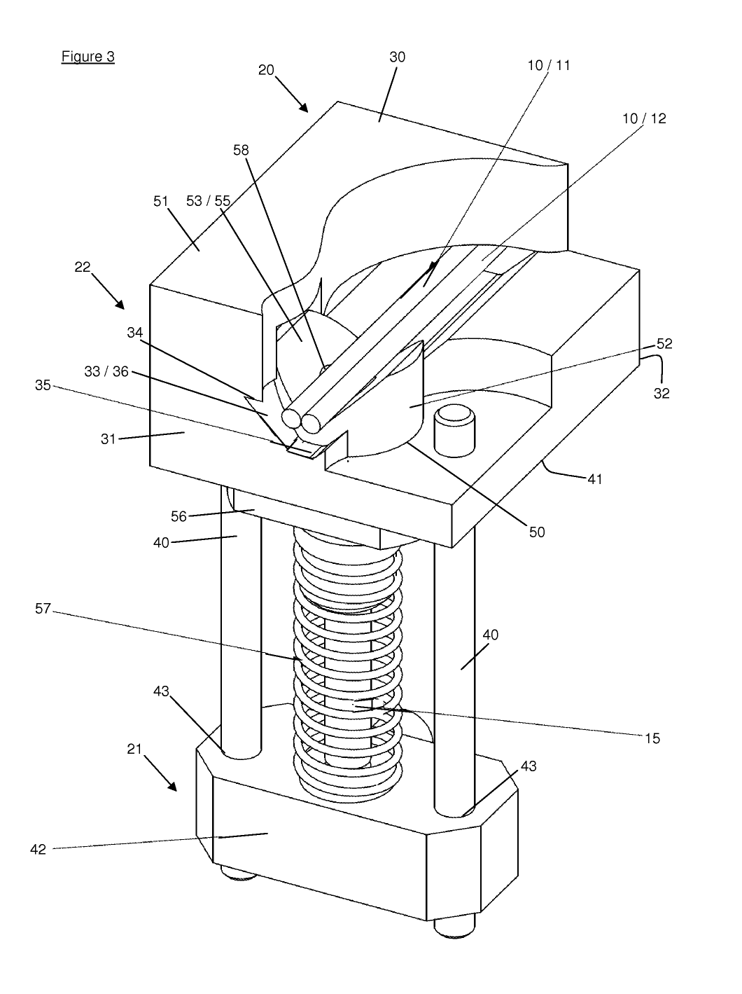

FIGS. 1 and 2 form an illustrative sequence showing a perspective view of part of an apparatus according to a first major embodiment of the present invention, during operation thereof;

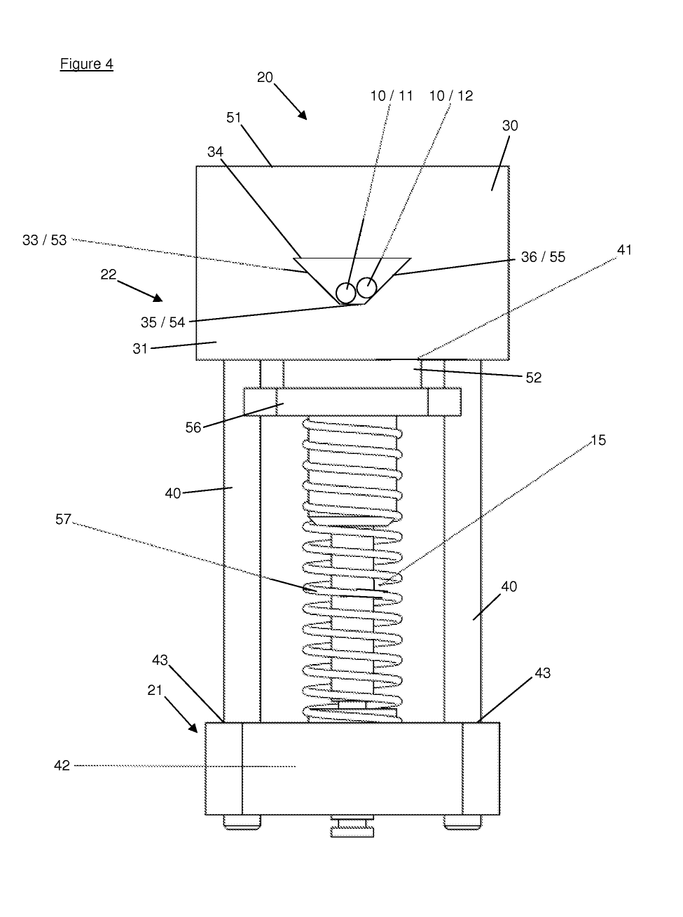

FIG. 3 shows a perspective, partially cutaway view of part of an apparatus according to a first variation of the first major embodiment of the present invention;

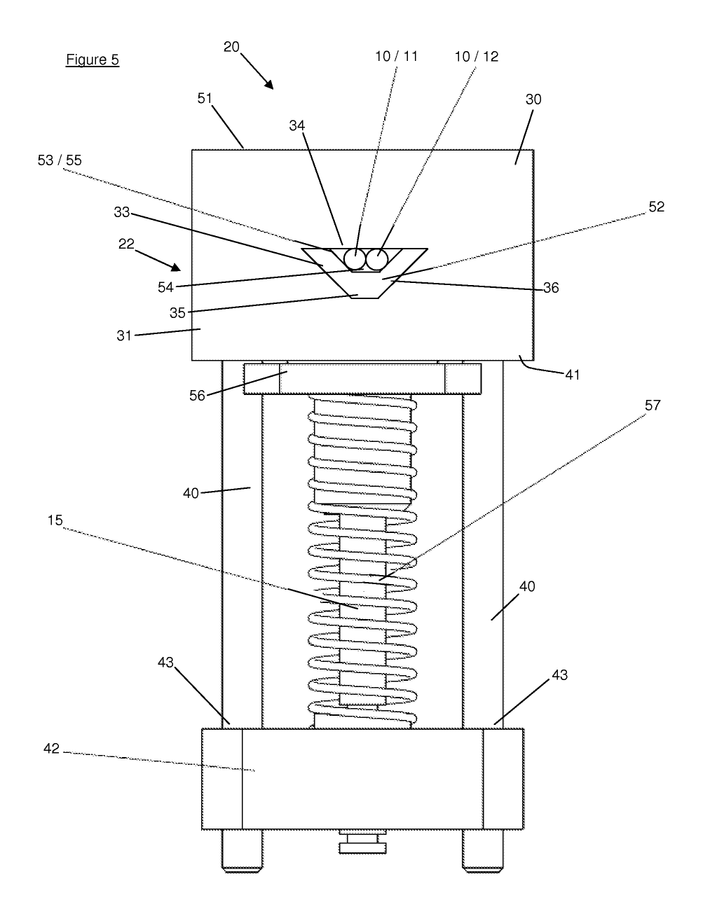

FIGS. 4 to 7 form an illustrative sequence showing a front view of the apparatus of FIG. 3, during operation thereof;

FIG. 8a shows a perspective view of part of an apparatus according to a second variation of the first major embodiment of the present invention;

FIGS. 8b and 8c show an alternative perspective view of the apparatus of FIG. 8a, but with the twisted pair cable omitted for clarity;

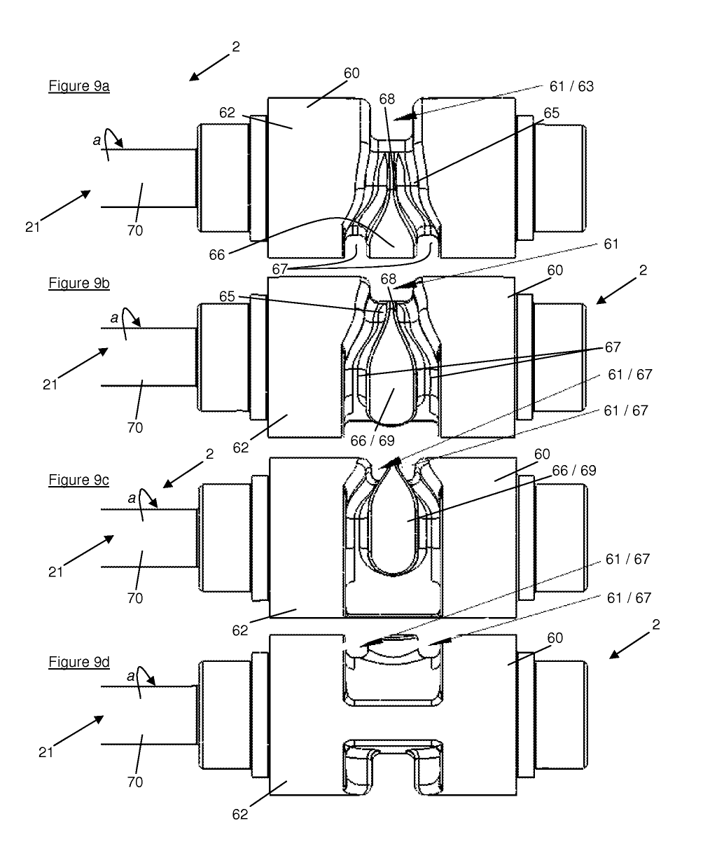

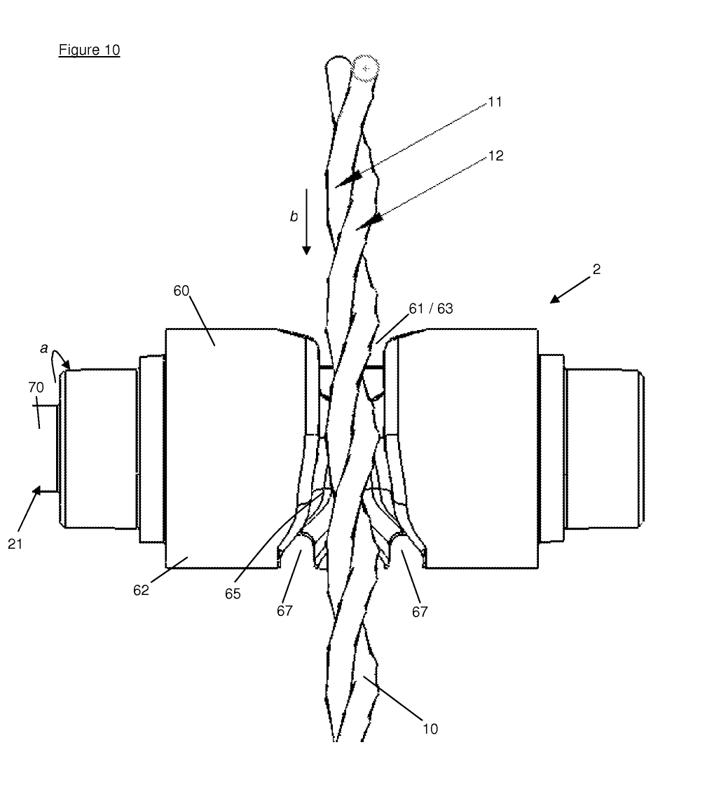

FIGS. 9a to 9d form an illustrative sequence showing a plan view of part of an apparatus according to a second major embodiment of the present invention, during operation thereof, but with the twisted pair cable omitted for clarity; and

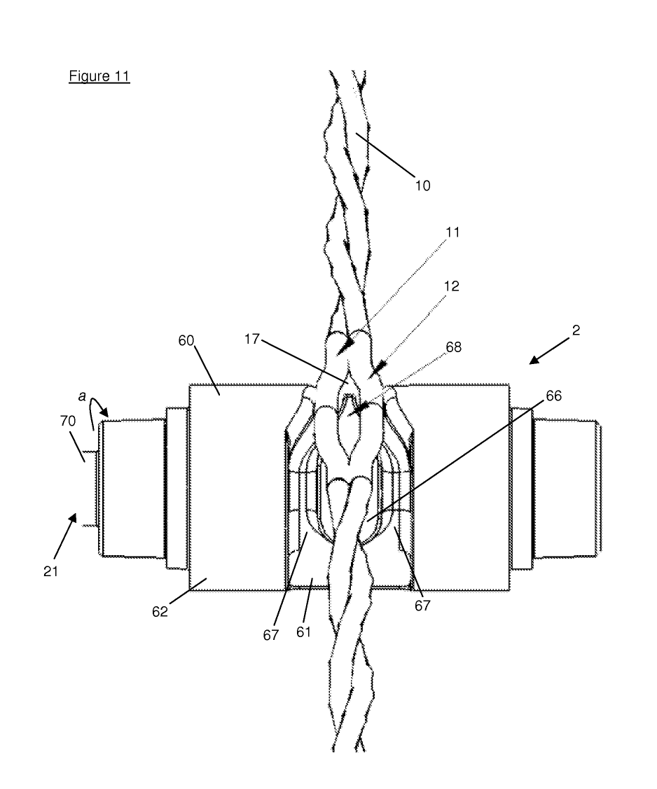

FIGS. 10 to 13 form an illustrative sequence showing a plan view of the apparatus of FIGS. 9a to 9d, during operation thereof with the twisted pair cable in place.

Referring first to FIGS. 1 and 2 there is shown part of an apparatus according to a first major embodiment of the present invention, generally indicated 1, for separating a length of twisted pair cable 10 into its constituent individual insulated wire conductors 11, 12. The apparatus 1 comprises a separator in the form of a cylindrical pin 15 having a conical tip 16 for insertion between the individual insulated wire conductors 11, 12, of the twisted pair cable 10, and cable drive means (not shown) for displacing the length of twisted pair cable 10 relative to the pin 15 in a direction a, b co-incident with the axis of the twisted pair cable 10.

As shown in FIG. 1, in the twisted pair cable 10, the insulated wire conductors 11, 12 are initially wound together in a generally helical formation. Insertion of the pin 15, as the twisted pair cable 10 is presented thereto in direction a, distorts the helical formation to form a loop 17 around the pin 15. The size of the loop 17 is generally determined by the diameter of the pin 15 and the mechanical properties and tension of the twisted pair cable 10.

As shown in FIG. 2, subsequent relative displacement between the twisted pair cable 10 and the pin 15 in a reverse direction b co-incident with the axis of the twisted pair cable 10, extends the initial loop 17 by plastic deformation of the individual insulated wire conductors 11, 12. The relative displacement b of the twisted pair cable 10 is effected by operation of the cable drive means (not shown) whilst the pin 15 is held in its active position as shown in FIGS. 1 and 2. The length of the loop 17 is determined by the relative displacement between the cable 10 and pin 15. The separated wire conductors 11, 12 may then be advanced in direction a, and cut laterally across the loop 17 to form prepared ends for insertion into insulated displacement connectors (not shown) or other electrical apparatus.

Referring now to FIGS. 3 to 7, there is shown part of an apparatus according to a first variation of the first major embodiment of the present invention, generally indicated 20. In addition to the features of the first major embodiment 10 described above with reference to FIGS. 1 and 2, the apparatus 20 further comprises separator drive means, generally indicated 21, and a clamping mechanism, generally indicated 22, as will now be described.

The apparatus 20 includes a generally cuboidal body 30 having opposed front and rear surfaces 31, 32, respectively, a lower face 41 and an upper face 51. A channel 33 extends between the front and rear surfaces 31, 32 for receiving a twisted pair cable 10. The channel 33 is generally U or V-shaped and has a ceiling 34, a base 35 and a pair of sidewalls 36 which diverge outwardly from the base 35 towards the ceiling 34 at an angle of approximately 45°. A bore 50 is formed in the lower surface 41 of the body 30, and extends towards the upper surface 51 of the body 30, intersecting the channel 33.

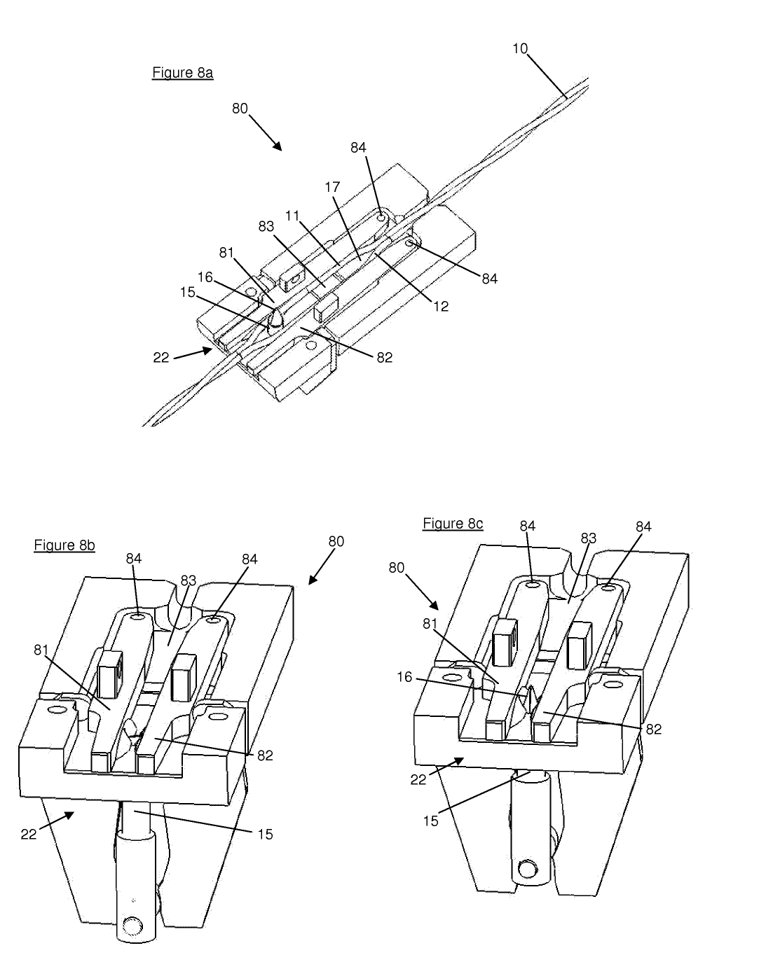

A pair of generally cylindrical parallel rails 40 depends from the lower face 41 of the body 30. A block 42, forming part of the separator drive means 21, and having the pin 15 mounted thereon, is slidably mounted on the rails 40 via a pair of complementary holes 43 formed through the block 42. A servo mechanism (not shown) also constituting part of the separator drive means 21 is arranged to move the block 42 along the rails 40 between an inactive position as shown in FIG. 3, in which the block 42 is distal from the body 30 such that the pin 15 is withdrawn from the twisted pair cable 10, and an active position as shown in FIG. 7, in which the block 42 is proximal to the body 30 such that the pin 15 is inserted between the individual insulated wire conductors 11,12.

Referring again to FIG. 3, the clamping mechanism 22 includes a cylindrical platform 52 provided in the bore 50 and adapted to form a close fit therewith, to permit relative sliding movement therebetween. The platform 52 has an upper face 53 which is complementarily shaped with the channel 33, in that the upper face 53 has a base 54 (not visible in FIG. 3) and two sidewalls 55 diverging outwardly from the base 54 at approximately 45°. Together, the ceiling 34 of the channel 33 and the upper face 53 of the platform 52 form, respectively, first and second clamping surfaces between which the twisted pair cable 10 is clamped prior to separation.

The underside 56 of the platform 52 is supported on a helical coil spring 57 mounted on the block 42 and arranged such that the spring 57 and the pin 15 are co-axial. The spring 57 is pre-tensioned such that when the block 42 is in its inactive position, as shown in FIG. 4, the upper face 53 of the platform 52 is co-planar with channel 33 so as to form a continuous surface upon which the twisted pair cable 10 may be supported.

Referring once more to FIG. 3, the platform 52 is further provided with a central aperture 58 extending therethrough and adapted to receive the pin 15 therein. This enables the pin 15 to be driven through the aperture 58 to separate the twisted pair cable 10 subsequent to clamping thereof.

The sequence of clamping and separating the twisted pair cable 10 into its constituent individual insulated wire conductors will now be described with reference to FIGS. 4 to 7.

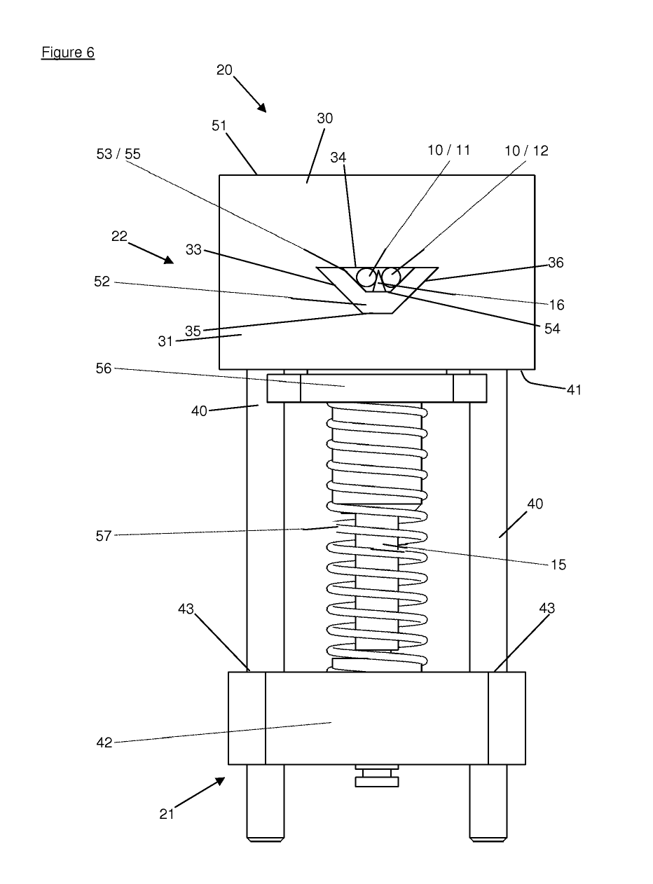

As shown in FIG. 4, starting with the separator pin 15 in its inactive position, the block 42 is located distal from the body 30 and the upper face 53 of the platform 52 is co-planar with the channel 33. Upon activation of the separator drive means 21, the block 42 moves upwardly along the rails 40, thus in turn compressing the spring 57 and so causing the platform 52 to move upwardly, thus displacing the upper face 53 of the platform 52 so as to clamp the insulated wire conductors 11, 12 of the twisted pair cable 10 between the upper face 53 of the platform 52 and the ceiling 34 of the channel 33, as shown in FIG. 5.

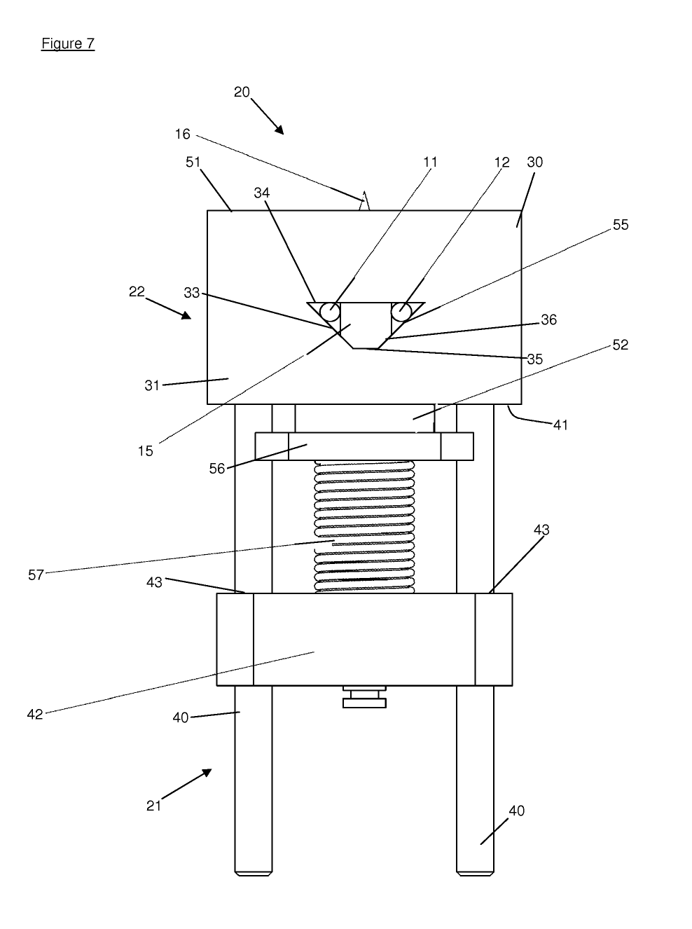

Continued upward movement of the block 42 along the rails 40, as shown in FIG. 6, causes the pin 15 to move upwardly through the aperture 58 (not visible in FIG. 6) in the platform 52 such that the tip 16 of the pin 15 is inserted between the individual insulated wire conductors 11,12 of the twisted pair cable 10. As the tip 16 of the pin 15 passes between the insulated wire conductors 11, 12 of the twisted pair cable 10, the individual insulated wire conductors 11, 12 separate and consequently ride upwardly along the diverging sidewalls 55 of the platform face 53. As shown in FIG. 7, this, together with the continued upward movement of the block 42 urging the pin 15 into its active position, not only results in complete separation of the insulated wire conductors 11, 12, but also forces the platform 52 downwardly against the bias of the helical coil spring 57, causing it to become fully compressed, and simultaneously releasing the clamping mechanism 22.

At this stage, the pin 15 has distorted the original helical formation of the twisted wire cable 10 to form a loop 17 (not visible in FIG. 7). The release of the clamping mechanism 22 enables the cable drive means (not shown) to effect relative displacement between the individual wire conductors 11, 12 and the pin 15 in a direction co-incident with the axis of the conductors 11, 12 thus extending the loop 17, whilst the pin 15 is held in its active position. Once the desired length of separated conductors 11, 12 has been obtained, the servo mechanism (not shown) of the separator drive means 21 is de-activated, with the result that the compressed spring 57 extends back to its initial state, urging the block 42 back to its starting position as shown in FIG. 4 and thus withdrawing the platform 52 and the pin 15 to the inactive position.

Referring now to FIGS. 8a to 8c, there is shown part of an apparatus according to a second variation of the first major embodiment of the present invention, generally indicated 80. The apparatus 80 differs from the first variation 20 of the first major embodiment described above in that the clamping mechanism 22 comprises a pair of opposed arms 81, 82 forming, respectively, the first and second clamping surfaces. The arms 81, 82 are arranged perpendicular to the longitudinal axis of the separator 15, and are adapted to clamp the twisted pair cable 10 from either side thereof, in the axial plane of the cable 10, as can be seen in FIG. 8a.

The opposed arms 81, 82 define a channel 83 therebetween, adapted to receive the twisted pair cable 10 as it is fed through the clamping mechanism 22 by the cable drive means (not shown). The opposed arms 81, 82 are arranged for movement in the plane of the cable 10 about a pair of pivot points 84. As can be seen from FIGS. 8b and 8c, the arms 81, 82 are arranged to move in concert with the motion of the separator 15. This acts both to effect clamping of the twisted wire cable 10 therebetween, and to change the profile of the channel 83 according to the status of the cable 10. That is to say, the channel 83 presents a different profile to the cable when it is in its twisted pair configuration 10 and when it is separated into individual insulated wire conductors 11, 12.

Referring now to FIGS. 9a to 9d, there is shown part of an apparatus according to a second major embodiment of the present invention, generally indicated 2. In this embodiment 2, the separator drive means, generally indicated 21, includes a cam shaft 70 adapted to cause rotation a of a cylindrical cam 60 carrying the separator 66. The separator 66 is thus moved between its inactive and active positions by rotational rather than translational motion.

The cylindrical cam 60 has a groove 61 formed in its circumferential face 62, said groove 61 having a changing profile as it extends around the face 62. FIGS. 9a to 9d show the cylindrical cam 60 in a number of rotational positions, so as to illustrate the changing profile of the groove 61 as it would be presented to a length of twisted pair cable 10.

FIG. 9a shows the cylindrical cam 60 with the separator 66 in its inactive position, i.e. located substantially on the underside of the cylindrical cam 60, when the cam 60 is seen in plan view from above. As can be seen from FIG. 9a, at one end of the groove 61 there is provided a relatively narrow mouth portion 63. The mouth portion 63 is adapted to receive the twisted pair cable 10 (not shown in FIGS. 9a to 9d) as it is fed in by the cable drive means (not shown). The narrow mouth portion 63 tapers outwardly to form a wider portion 65 within which is located a separator 66, upstanding from the surface of the groove 61. The separator 66 effectively divides the groove 61 into two sub-grooves 67, one passing either side of the separator 66. This can best be seen in FIG. 9b which shows the apparatus 2 with the cylindrical cam 60 further rotated as indicated by arrow a.

As can also be seen in FIG. 9b, the separator 66 has a tapered tip 68 adapted for insertion between the individual insulated wire conductors 11,12 (not shown in FIGS. 9a to 9d) of the twisted pair cable 10, and tapers outwardly to form a lozenge-shaped body 69.

As shown in FIG. 9c, with the cylindrical cam 60 rotated further in direction a, the separator 66 is brought fully into its active position, i.e. located substantially on the upper side of the cylindrical cam 60 when the cam 60 is seen in plan view. The separator 66 is thus arrange to split the twisted pair cable 10 into its constituent insulated wire conductors 11,12, with the body 69 of the separator being located between the conductors 11, 12 so as to guide one of said conductors 11, 12 into each of the sub-grooves 67.

As shown in FIG. 9d, with the cylindrical cam 60 rotated still further in direction a, the separator 66 begins to return to its inactive position on the underside of the cam 60. The cam 60 would only be rotated into this position once the displacement of the separated conductors 11, 12 relative to the separator 66 had been carried out, with the separator 66 held in its active position as shown in FIG. 9c.

The sequence of separating the twisted pair cable 10 into its constituent individual insulated wire conductors 11,12 using the apparatus of the second major embodiment 2, will now be described with reference to FIGS. 10 to 13.

As shown in FIG. 10, starting with the separator 66 (not visible in FIG. 10) arranged in its inactive position on the underside of the cylindrical cam 60, the narrow mouth portion 63 of the groove 61 receives the twisted pair cable 10 as it is fed in by the cable drive means (not shown) in a forward direction as indicated by arrow b. The separator drive means 21 is then activated, to rotate the cam shaft 70 and in turn the cylindrical cam 60, as indicated by arrow a.

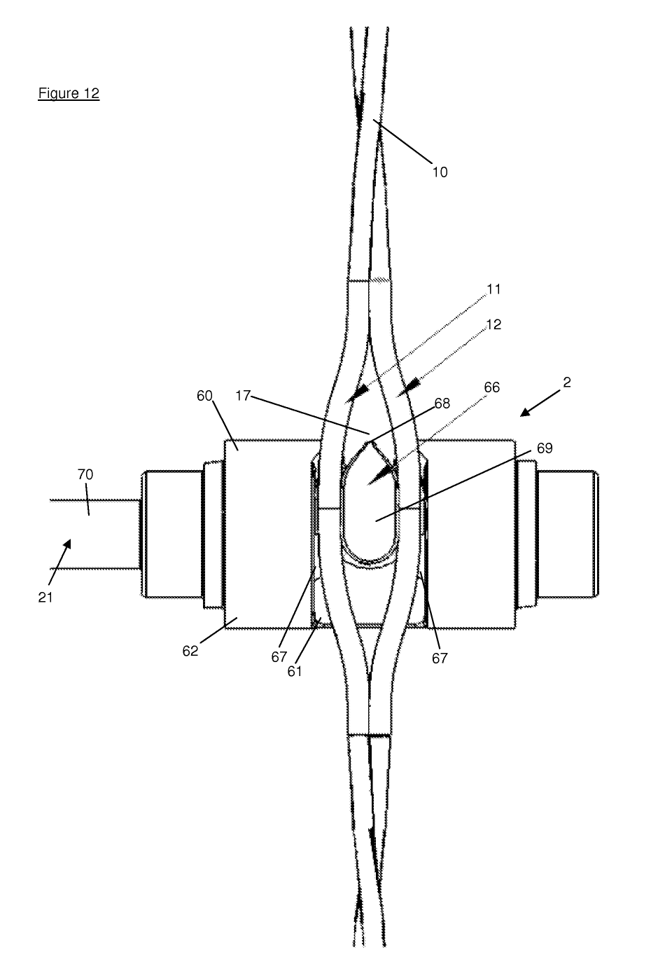

Referring now to FIG. 11, this shows the apparatus 2, with the cylindrical cam 60 rotated in direction a so as to move the separator 66 towards its active position. As can been seen in FIG. 11, the tip 68 of the separator 66 now inserts between the individual insulated wire conductors 11,12 of the twisted pair cable 10 so as to start to form a loop 17 in the twisted pair cable 10.

Further rotation of the cylindrical cam 60 in direction a brings the separator 66 fully into its active position, as shown in FIG. 12. The body 69 of the separator 66 is now located fully between the individual insulated wire conductors 11,12 so as to form a loop 17 in the twisted pair cable 10, and to urge each of the insulated wire conductors 11,12 into its respective sub-groove 67.

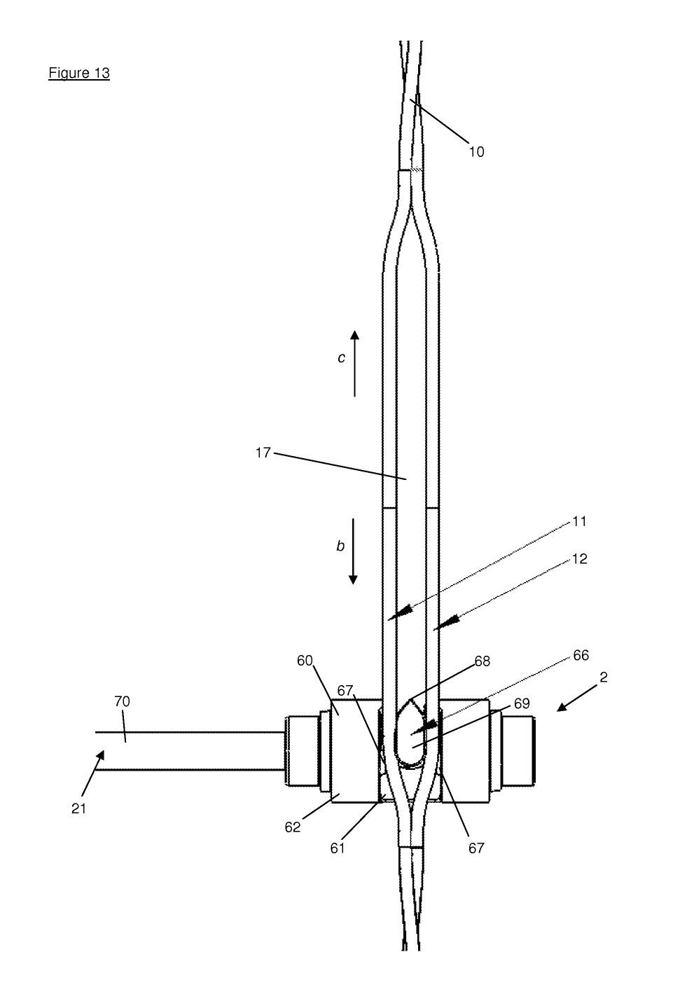

At this stage, the rotation of the cylindrical cam 60 is stopped, and the separator 66 is held in its active position. As shown in FIG. 13, the separated conductors 11, 12 are then pulled back past the separator 66 by the cable drive means (not shown) operating in a reverse direction, as indicated by arrow c. This causes the loop 17 to be extended, thus producing a length of cable consisting of separated, opposed, parallel insulated wire conductors 11,12. Pulling the conductors 11, 12 back past the separator 66 causes plastic deformation of the conductors 11, 12, ensuring that the conductors 11, 12 do not spring back into their initial coiled condition.

Once the desired length of separated conductors 11,12 has been achieved, the cable drive means (not shown) is run in a forward direction b once more, so as to present the separated wire conductors 11,12 for cutting laterally across the loop 17 to form prepared ends for insertion into insulated displacement connectors (not shown) or other electrical apparatus. Rotation a of the cylindrical cam 60 is then re-commenced to return the separator 66 to its inactive position, ready for the next operation.

What is claimed is:

1. Apparatus for separating a length of twisted pair cable having a longitudinal axis, into constituent individual insulated wire conductors, said apparatus comprising:
a separator adapted to be inserted between said individual insulated wire conductors constituting said twisted pair cable; and
cable drive means adapted to displace said length of twisted pair cable relative to said inserted separator in a direction co-incident with said longitudinal axis of said twisted pair cable, thereby causing plastic deformation of said individual insulated wire conductors so as to form a length of separated cable comprising a pair of substantially parallel separated individual insulated wire conductors.

2. The apparatus of claim 1, further comprising separator drive means adapted to drive said separator between an inactive position in which the separator is withdrawn from the twisted pair cable, and an active position in which the separator is inserted between the individual insulated wire conductors constituting the twisted pair cable.

3. The apparatus of claim 2, in which the cable drive means is adapted to effect forward translational motion of the twisted pair cable thereby to present said twisted pair cable to the separator prior to insertion thereof, and also to effect reverse translational motion of the cable subsequent to insertion of the separator, thereby to separate the individual insulated wire conductors and cause plastic deformation thereof.

4. The apparatus of claim 2, in which the separator drive means is adapted to hold the separator in its active position whilst the cable drive means effects displacement of the twisted pair cable relative to the separator, thereby to separate the individual insulated wire conductors and cause plastic deformation thereof.

5. The apparatus of claim 2, further comprising an automated controller in communication with the cable drive means and the separator drive means and adapted thereby to generate pre-determined lengths of separated cable on demand.

6. The apparatus of claim 5, in which the separator drive means comprises a servo mechanism adapted to drive the separator from its inactive position to its active position.

7. (canceled)

8. (canceled)

9. (canceled)

10. The apparatus of claim 5, further comprising a clamping mechanism adapted to secure the twisted pair cable between first and second clamping surfaces, thereby to facilitate insertion of the separator.

11. The apparatus of claim 5, in which the clamping mechanism comprises a fixed body on which said first clamping surface is provided, a moveable platform on which said second clamping surface is provided, and clamping drive means adapted to drive said moveable platform between an inactive position in which said first and second clamping surfaces are distal, and an active position in which said first and second clamping surfaces are brought into close proximity, thereby to effect clamping of the twisted pair cable.

12. (canceled)

13. The apparatus of claim 11, in which second clamping surface comprises a channel adapted to accommodate the twisted pair cable, and in which said moveable platform comprises an aperture extending through said second clamping surface and adapted to receive the separator therein, said separator being adapted to be driven through said aperture thereby to separate the individual insulated wire conductors.

14. The apparatus of claim 13, in which said second clamping surface forms a trough having angled sidewalls, such that in use, the separator acts to urge each respective individual insulated wire conductor against an opposed angled sidewall.

15. (canceled)

16. (canceled)

17. The apparatus of claim 11, in which the clamping drive means comprises a pre-tensioned spring mounted on the moveable platform and adapted to apply a force to said moveable platform upon compression of said pre-tensioned spring.

18. The apparatus of claim 10, in which the clamping mechanism comprises a pair of opposed arms arranged perpendicular to the separator, said pair of opposed arms being adapted to clamp the twisted pair cable from each side of said twisted pair cable, each member of said pair of opposed arms constituting, respectively, said first and second clamping surfaces, and in which a channel is defined between said pair of opposed arms, said channel being adapted to receive the twisted pair cable.

19. (canceled)

20. The apparatus of claim 18, in which said opposed arms are adapted to move in concert with motion of the separator, thereby to effect clamping of the twisted pair cable, and to change said channel's profile according to said cable's status.

21. The apparatus of claim 2, in which the separator drive means is adapted to effect rotational motion of the separator between its inactive and active positions, and in which the separator drive means comprises a cam having a surface adapted to bear against the twisted pair cable as said cam rotates, and wherein the separator is provided at a location on said surface.

22. (canceled)

23. (canceled)

24. The apparatus of claim 21, wherein the cam is a cylindrical cam having at least one groove extending at least part way around said cylindrical cam and adapted to receive the twisted pair cable, said grove defining a pair of opposed side walls constituting guide means for aligning the separator with the twisted pair cable.

25. (canceled)

26. The apparatus of claim 24, in which said groove has a generally U-shaped profile, and constitutes said surface adapted to bear against the twisted pair cable, and in which the separator is formed in said groove and projects outwardly therefrom.

27. The apparatus of claim 26, in which the groove divides into a pair of opposed parallel sub-grooves adjacent the separator, each said sub-groove being adapted to receive one member of said pair of insulated wire conductors, and wherein one member of said pair of sub-grooves passes to each side of the separator, thereby to facilitate separation of the twisted pair cable.

28. (canceled)

29. (canceled)

30. A method of separating a length of twisted pair cable having a longitudinal axis, into constituent individual insulated wire conductors, comprising:
inserting a separator between said individual insulated wire conductors constituting the twisted pair cable; and
activating cable drive means to displace said length of twisted pair cable relative to said inserted separator in a direction co-incident with said longitudinal axis of said twisted pair cable, thereby causing plastic deformation of said individual insulated wire conductors, so as to form a length of separated cable comprising a pair of substantially parallel separated individual insulated wire conductors.

31. The method of claim 30, in which the separator is driven between an inactive position in which the separator is withdrawn from said twisted pair cable, and an active position in which the separator is inserted between said individual insulated wire conductors constituting said twisted pair cable.

32. The method of claim 31, in which said twisted pair cable is driven in a forward translational motion to present said twisted pair cable to the separator prior to insertion thereof, and is then driven in a reverse translational motion subsequent to insertion of the separator, thereby to separate said individual insulated wire conductors and cause plastic deformation thereof, and in which the separator is held in its active position whilst said twisted pair cable is displaced relative to the separator, thereby to separate said individual insulated wire conductors and cause plastic deformation thereof.

33. (canceled)

34. (canceled)

35. (canceled)

36. (canceled)

37. (canceled)

38. (canceled)
